(19) United States
(12) Patent Application Publication
(10) Pub. No.: US 2015/0228100 A1
(43) Pub. Date: Aug. 13, 2015

(54) METHOD AND APPARATUS FOR DISPLAYING CONTENT

(71) Applicant: TENCENT TECHNOLOGY (SHENZHEN) COMPANY LIMITED, Shenzhen City, Guangdong (CN)

(72) Inventors: Na Xun, Shenzhen (CN); Guichao Liu, Shenzhen (CN)

(73) Assignee: TENCENT TECHNOLOGY (SHENZHEN) COMPANY LIMITED, Shenzhen City, Guangdong (CN)

(21) Appl. No.: 14/427,048

(22) PCT Filed: Aug. 26, 2013
(86) PCT No.: PCT/CN2013/082280

§ 371 Date: Mar. 10, 2015

(30) Foreign Application Priority Data
Sep. 11, 2012 (CN) 201210334122.5

(51) Int. Cl. G06T 11/60; G06T 3/20

(52) U.S. Cl. CPC G06T 11/60; G06T 3/20

(57) ABSTRACT

The present disclosure a method and apparatus for displaying content, which belong to the field of computers. The method includes: obtaining configuration information of contents needed to be displayed, wherein the configuration information of the contents at least includes column numbers, line numbers, heights and display unit types; calculating offset ranges of the contents according to the column numbers, line numbers and heights of the contents; and displaying the contents respectively in multiple columns according to the column numbers, display unit types and the offset ranges of the contents. The apparatus includes an obtaining module, a calculating module and a display module. The present disclosure can improve utilization of space resources of a display screen of a terminal.

### CROSS-REFERENCE TO RELATED APPLICATIONS

This application is a U.S. National Phase application under 35 U.S.C. §371 of International Application No. PCT/CN2013/082280, filed Aug. 26, 2013, entitled “METHOD AND APPARATUS FOR DISPLAYING CONTENT”, the entire contents of which are incorporated herein by reference.

### FIELD OF THE DISCLOSURE

The present disclosure relates to computers, and more particularly to a method and apparatus for displaying content.

### BACKGROUND

With the rapid development of terminal technology, mobile terminals have been widely used. For example, users can use mobile terminals to display contents for themselves. The contents can include images and/or texts, etc.

When a current terminal displays contents needed to be displayed, according to a number of the contents needed to be displayed, the terminal needs to divide a display interface of one user interface (UI) into multiple rows of equal height. Each of the contents corresponds to one row. The terminal displays the variety of contents in the corresponding rows, respectively, according to orders of the variety of contents.

In process of implementation of the present disclosure, inventors have found there are at least following problems in the related art:

Since a display screen of the terminal is wider, and each content is displayed in each row according to the method for displaying content in the related art, thus, there are a lot of unused space resources of the display screen.

### SUMMARY

In order to improve utilization of space resources of a display screen of a terminal, the present disclosure provides a method and apparatus for displaying content. The technical solution is as follows:

A method for displaying content includes:

obtaining configuration information of contents needed to be displayed, wherein the configuration information of the contents at least includes column numbers, line numbers, heights and display unit types;

calculating offset ranges of the contents according to the column numbers, line numbers and heights of the contents; and

displaying the contents respectively in multiple columns according to the column numbers, display unit types and the offset ranges of the contents;

the displaying the contents respectively in multiple columns according to the column numbers, display unit types and the offset range of the contents comprises:

selecting contents whose offset ranges overlap with a first display range from the contents needed to be displayed, wherein the first display range is greater than or equal to 0 and less than or equal to a height of a display screen of a terminal;

loading the selected contents in multiple columns into a display interface according to column numbers, display unit types and offset ranges of the selected contents; and

moving the display interface and displaying contents in the first display range on the display screen of the terminal.

The loading the selected contents in multiple columns into a display interface according to column numbers, display unit types and offset ranges of the selected contents comprises:

obtaining corresponding display units according to the display unit types corresponding to the selected contents;

configuring the display units according to heights of the selected contents, and positioning the display units in the display interface according to the column numbers and the offset ranges of the selected contents; and

loading the selected contents into the display units.

The obtaining corresponding display units according to the display unit types corresponding to the selected contents comprises:

determining whether there are corresponding displaying units in a display unit recycle bin, according to the display unit types corresponding to the selected contents;

if there are corresponding displaying units in the display unit recycle bin, then obtaining the corresponding display units from the display unit recycle bin according to the display unit types corresponding to the selected contents;

if there are not corresponding displaying units in the display unit recycle bin, then creating corresponding displaying units according to the display unit types corresponding to the selected contents.

After the displaying the contents respectively in multiple columns according to the column numbers, display unit types and the offset ranges of the contents, the method further comprises:

when the user moves displayed contents, periodically obtaining contents which move into the display screen of the terminal and displaying the contents which move into the display screen of the terminal respectively in multiple columns.

The periodically obtaining contents which move into the display screen of the terminal and displaying the contents which move into the display screen of the terminal respectively in multiple columns comprises:

obtaining a displacement amount and a movement direction of contents moved by a user in a current period, and obtain a second display range according to the first display range, the displacement amount and the movement direction;

obtaining the contents which move into the display screen of the terminal according to the first display range and the second display range;

according to column numbers, display unit types and the displacement amount of the contents which move into the display screen of the terminal, load in multiple columns the contents which move into the display screen of the terminal into the display interface;

moving the display interface and displaying contents in the second display range on the display screen of the terminal.

The obtaining a second display range according to the first display range, the displacement amount and the movement direction comprises:

if the movement direction is downward, performing a summing operation on the first display range and the displacement amount to obtain a second display range;

if the movement direction is upward, performing a difference operation on the first display range and the displacement amount to obtain a second display range.

The obtaining the contents which move into the display screen of the terminal according to the first display range and the second display range comprises:

obtaining contents whose displacement amounts are overlapped with the second display range but not overlapped with the first display range from the contents needed to be displayed; wherein the contents whose displacement amounts are overlapped with the second display range but not overlapped with the first display range are the contents which move into the display screen of the terminal.

After the displaying contents in the second display range on the display screen of the terminal, the method further comprises:

updating the first display range to be the second display range.

After the obtaining a second display range according to the first display range, the displacement amount and the movement direction, the method further comprises:

obtaining contents which move out of the display screen of the terminal according to the second display range and recycling display units corresponding to the contents which moves out of the display screen of the terminal.

The obtaining contents which move out of the display screen of the terminal according to the second display range and recycling display units corresponding to the contents which moves out of the display screen of the terminal comprises:

obtaining contents whose displacement amounts are not overlapped with the second display range from contents currently included in the display interface; wherein the contents whose displacement amounts are not overlapped with the second display range are the contents which move out of the display screen of the terminal;

caching the display units corresponding to the contents which move out of the display screen of the terminal into a display unit recycle bin; and

releasing memory space occupied by the contents which move out of the display screen of the terminal.

An apparatus for displaying content includes:

an obtaining module configured to obtain configuration information of contents needed to be displayed, wherein the configuration information of the contents at least includes column numbers, line numbers, heights and display unit types;

a calculating module configured to calculate offset ranges of the contents according to the column numbers, the line numbers and the heights of the contents;

a display module configured to display the contents respectively in multiple columns according to the column numbers, the display unit types and the offset ranges of the contents;

the display module includes:

a first selecting unit configured to select contents whose offset ranges overlap with a first display range from the contents needed to be displayed; wherein the first display range is greater than or equal to 0 and less than or equal to a height of a display screen of a terminal;

a first loading unit configured to load the selected contents in multiple columns into a display interface, according to column numbers, display unit types and offset ranges of the selected contents; and

a first display unit configured to move the display interface and display contents in the first display range on the display screen of the terminal.

The first loading unit comprises:

a first obtaining sub-unit configured to obtain corresponding display units according to the display unit types corresponding to the selected contents;

a positioning sub-unit configured to configure the display units according to the heights of the selected contents and position the display units in the display interface according to the column numbers and the offset ranges of the selected content; and

a loading sub-unit configured to load the selected contents into the display units.

The first obtaining sub-unit is configured to determine whether there are corresponding displaying units in a display unit recycle bin according to the display unit types corresponding to the selected contents; if there are corresponding displaying units in the display unit recycle bin, obtain the corresponding display units from the display unit recycle bin according to the display unit types corresponding to the selected contents; if there are not corresponding displaying units in the display unit recycle bin, create corresponding displaying units according to the display unit types corresponding to the selected contents.

The apparatus further comprises:

an obtaining-displaying module configured to, when a user moves displayed contents, periodically obtain contents which move into the display screen of the terminal and display in multiple columns the contents which move into the display screen of the terminal.

The obtaining-displaying module comprises:

a first obtaining unit configured to obtain a displacement amount and a movement direction of contents moved by the user in a current period, and obtain a second display range according to the first display range, the displacement amount and the movement direction;

a second obtaining unit configured to obtain contents which move into the display screen of the terminal according to the first display range and the second display range;

a second loading unit configured to, according to column numbers, display unit types and the displacement amount of the contents which move into the display screen of the terminal, load in multiple columns the contents which move into the display screen of the terminal into the display interface;

a second display unit configured to move the display interface and display contents in the second display range on the display screen of the terminal.

The first obtaining unit comprises:

a second obtaining sub-unit configured to obtain the displacement amount and the movement direction of the contents moved by the user in the current period;

a first computing unit configured to, if the movement direction is downward, perform a summing operation on the first display range and the displacement amount to obtain a second display range; and

a second computing unit configured to, if the movement direction is upward, perform a difference operation on the first display range and the displacement amount to obtain a second display range.

The second obtaining unit is configured to obtain contents whose displacement amounts are overlapped with the second display range but not overlapped with the first display range from the contents needed to be displayed; wherein the contents whose displacement amounts are overlapped with the second display range but not overlapped with the first display range are the contents which move into the display screen of the terminal.

The apparatus further comprises:

an updating module configured to update the first display range to be the second display range.

The apparatus further comprises:

a recycling module configured to, obtain contents which move out of the display screen of the terminal according to the second display range and recycle display units corresponding to the contents which moves out of the display screen of the terminal.

The recycling module includes:

a third obtaining unit configured to obtain contents whose displacement amounts are not overlapped with the second display range from contents currently included in the display interface; wherein the contents whose displacement amounts are not overlapped with the second display range are the contents which move out of the display screen of the terminal;

a cache unit configured to cache display units corresponding to the contents which move out of the display screen of the terminal into a display unit recycle bin;

a release unit configure to release memory space occupied by the contents which move out of the display screen of the terminal.

In one embodiment of the present disclosure, obtaining configuration information of contents needed to be displayed, and the configuration information of the contents at least including column numbers, line numbers, heights and display unit types; calculating offset ranges of the contents according to the column numbers, line numbers and heights of the contents; displaying the contents respectively in multiple columns according to the column numbers, display unit types and the offset ranges of the contents, since the contents can be displayed in multiple columns on a display screen of a terminal, and thus the utilization of space resources of the display screen of the terminal can be improved.

### BRIEF DESCRIPTION OF DRAWINGS

FIG. 1 is a flowchart of a method for displaying content according to an embodiment 1 of the present disclosure;

FIG. 2 is a flowchart of a method for displaying content according to an embodiment 2 of the present disclosure;

FIG. 3 is a schematic diagram of a first display interface according to the embodiment 2 of the present disclosure;

FIG. 4 is a schematic diagram of a second display interface according to the embodiment 2 of the present disclosure;

FIG. 5 is a schematic diagram of a third display interface according to the embodiment 2 of the present disclosure;

FIG. 6 is a schematic diagram of a first display screen according to the embodiment 2 of the present disclosure;

FIG. 7 is a schematic diagram of a fourth display interface to the embodiment 2 of the present disclosure;

FIG. 8 is a schematic diagram of a third display screen according to the embodiment 2 of the present disclosure; and

FIG. 9 is a schematic diagram of an apparatus for displaying content according to an embodiment 3 of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

### Embodiment 1

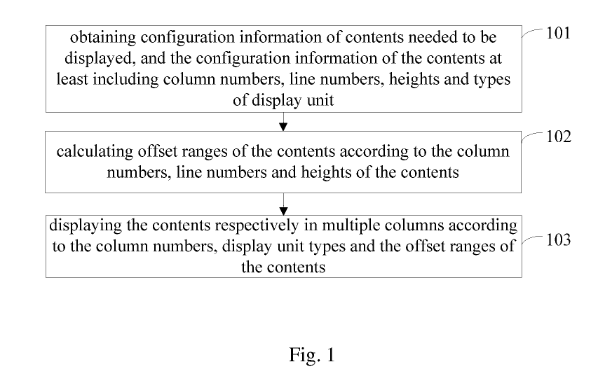

As shown in FIG. 1, this embodiment of the present disclosure provides a method for displaying content, which includes:

Block 101: obtaining configuration information of contents needed to be displayed, and the configuration information of the contents at least including column numbers, line numbers, heights and display unit types;

Block 102: calculating offset ranges of the contents according to the column numbers, line numbers and heights of the contents;

Block 103: displaying the contents respectively in multiple columns according to the column numbers, display unit types and the offset ranges of the contents.

In the embodiment of the present disclosure, obtaining configuration information of contents needed to be displayed, and the configuration information of the contents at least including column numbers, line numbers, heights and display unit types; calculating offset ranges of the contents according to the column numbers, line numbers and heights of the contents; displaying the contents respectively in multiple columns according to the column numbers, display unit types and the offset ranges of the contents, since the contents can be displayed in multiple columns on a display screen of a terminal, and thus the utilization of space resources of the display screen of the terminal can be improved.

### Embodiment 2

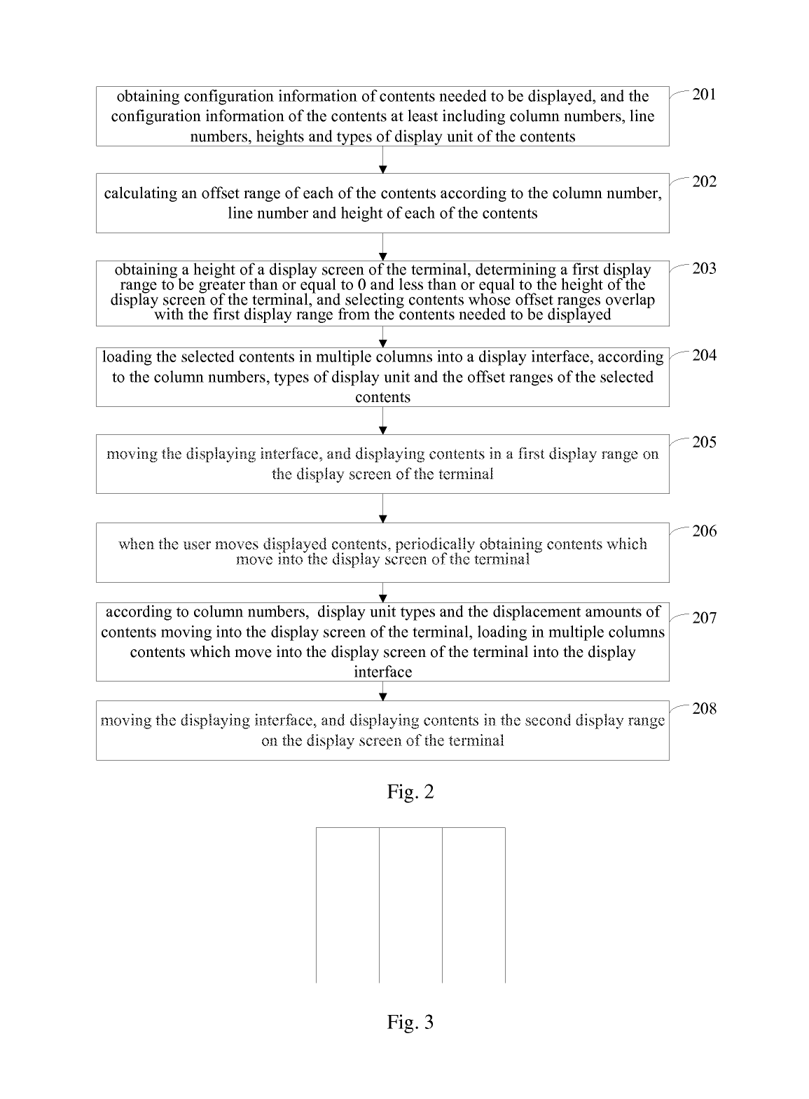

This embodiment of the present disclosure provides a method for displaying content, in which a user can configure in advance a number of columns of contents displayed on a terminal so that the terminal can display contents in multiple columns. As shown in FIG. 2, the method includes:

Block 201: obtaining configuration information of contents needed to be displayed, and the configuration information of the contents at least including column numbers, line numbers, heights and display unit types of the contents;

In this embodiment, there are multiple contents needed to be displayed. For any one of the contents needed to be displayed, one user can input configuration information of this content into a terminal, and the configuration information at least includes a column number and a line number for displaying this content, a height of this content and a display unit type for displaying this content. The user can input configuration information of every other one of the contents needed to be displayed into the terminal according to the above similar input method.

Accordingly, the terminal receives configuration information of each of the contents needed to be displayed, and stores the configuration information of each of the contents needed to be displayed.

In this embodiment, the unit of height can be pixel.

For example, assuming that there are 15 contents needed to be displayed, and the contents needed to be displayed can include contents 1, 2, 3, 4, 5, 6, 7, 8, 9, 10, 11, 12, 13, 14 and 15. Referring To table 1, one user input configuration information of the contents 1, 2, 3, 4, 5, 6, 7, 8, 9, 10, 11, 12, 13, 14 and 15 into the terminal, respectively.

TABLE 1

| | configuration information | | | |
|---|---|---|---|---|
| content | column number | line number | height | display unit type |
| content 1 | 1 | 1 | 20 | type 1 |
| content 2 | 1 | 2 | 15 | type 1 |
| content 3 | 1 | 3 | 13 | type 2 |
| content 4 | 1 | 4 | 8 | type 3 |
| content 5 | 1 | 5 | 17 | type 4 |
| content 6 | 2 | 1 | 15 | type 2 |
| content 7 | 2 | 2 | 6 | type 3 |
| content 8 | 2 | 3 | 25 | type 1 |
| content 9 | 2 | 4 | 16 | type 4 |
| content 10 | 2 | 5 | 5 | type 1 |
| content 11 | 3 | 1 | 5 | type 1 |
| content 12 | 3 | 2 | 10 | type 2 |
| content 13 | 3 | 3 | 20 | type 4 |
| content 14 | 3 | 4 | 12 | type 3 |
| content 15 | 3 | 5 | 10 | type 4 |

Block 202: calculating an offset range of each of the contents according to the column number, line number and height of each of the contents;

For example, for the content 1, an offset range of the content 1, which can be calculated according to the column 1, line number 1 and height 20 of the content 1, can be greater than or equal to 0 and less than or equal to 20. For the content 2, an offset range of the content 2, which can be calculated according to the column 1, line number 2 and height 15 of the content 2, can be greater than 20 and less than or equal to 35. For the content 3, an offset range of the content 3, which can be calculated according to the column 1, line number 3 and height 13 of the content 3, can be greater than 35 and less than or equal to 48. Offset ranges of the remaining contents 4, 5, 6, 7, 8, 9, 10, 11, 12, 13, 14 and 15 can be respectively calculated according to the above same method, and the obtained results are shown in Table 2.

TABLE 2

| content | offset range |
|---|---|
| content 1 | greater than or equal to 0 and less than or equal to 20 |
| content 2 | greater than 20 and less than or equal to 35 |
| content 3 | greater than 35 and less than or equal to 48 |
| content 4 | greater than 48 and less than or equal to 56 |
| content 5 | greater than 56 and less than or equal to 75 |
| content 6 | greater than or equal to 0 and less than or equal to 15 |
| content 7 | greater than 15 and less than or equal to 24 |
| content 8 | greater than 24 and less than or equal to 46 |
| content 9 | greater than 46 and less than or equal to 62 |
| content 10 | greater than 62 and less than or equal to 67 |
| content 11 | greater than or equal to 0 and less than or equal to 5 |
| content 12 | greater than 5 and less than or equal to 15 |
| content 13 | greater than 15 and less than or equal to 35 |
| content 14 | greater than 35 and less than or equal to 48 |
| content 15 | greater than 48 and less than or equal to 58 |

Block 203: obtaining a height of a display screen of the terminal, determining a first display range to be greater than or equal to 0 and less than or equal to the height of the display screen of the terminal, and selecting contents whose offset ranges overlap with the first display range from the contents needed to be displayed;

For example, assuming that a height of a display screen of a terminal is 30 pixels, then determining a first display range to be greater than or equal to 0 and less than or equal to 30 pixels, and selecting contents whose offset ranges overlap with the first display range greater than or equal to 0 and less than or equal to 30 pixels, including contents 1, 2, 6, 7, 8, 11, 12 and 13, from the contents 1, 2, 3, 4, 5, 6, 7, 8, 9, 10, 11, 12, 13, 14 and 15.

Block 204: loading the selected contents in multiple columns into a display interface, according to the column numbers, display unit types and the offset ranges of the selected contents;

Specifically, for any one of the selected contents, obtaining a corresponding display unit according to a display unit type corresponding to this content; configuring the display unit according to the height of this content; positioning the display unit in the display interface according to a column number and an offset range of this content, and loading this content into the display unit. Every other one of the selected contents can be loaded into the display interface according to the above same method.

The obtaining a corresponding display unit according to a display unit type corresponding to this content can specifically be:

determining whether there is a corresponding displaying unit in a display unit recycle bin, according to the display unit type corresponding to this content; if there is a corresponding displaying unit in the display unit recycle bin, then obtaining the corresponding display unit from the display unit recycle bin according to the display unit type corresponding to this content; if there is not a corresponding displaying unit in the display unit recycle bin, then creating a corresponding displaying unit according to the display unit type corresponding to this content.

Creation of the display unit needs to take time and resources, while obtaining the corresponding display unit from the display unit recycle bin can reduce time and consumed resources for displaying contents.

Further, a display interface with multiple columns of equal width can be created in advance according to the number which is of columns of displayed contents and is configured by the user, and an offset of a top of the display interface is 0.

The display interface can be a user interface (UI).

For example, referring to FIG. 3, assuming that a number which is of columns of displayed contents and is configured by the user is 3, creating in advance a display interface with 3 columns of equal width; there is a display unit recycle bin in the terminal, and the display unit recycle bin includes a display unit 1, a display unit 2 and a display unit 3; types of the display units 1 and 2 are type 1, a type of the display unit 3 is type 2.

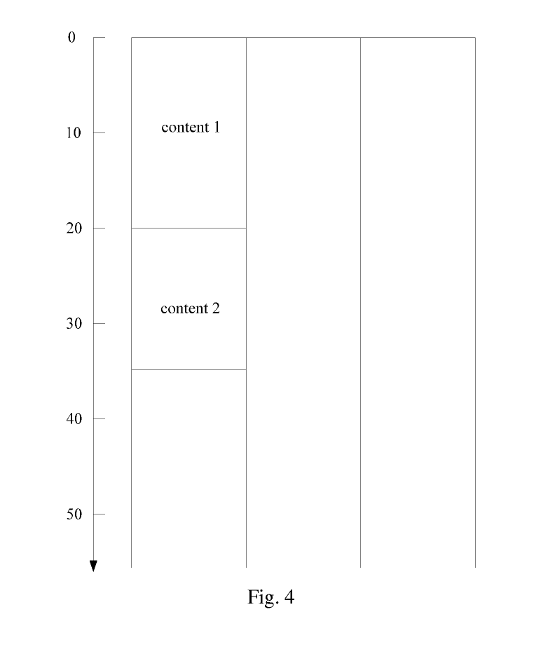

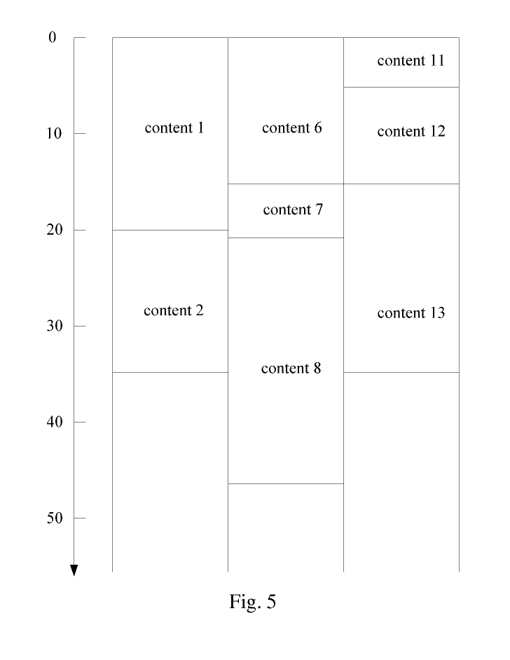

Referring to FIG. 4, for the content 1, according to the display unit type 1 of the content 1, one display unit whose type is the type 1, assuming that it is the display unit 1, can be obtained from the display unit recycle bin. The display unit 1 can be configured according to the height 20 of the content 1, i.e., configuring the height of the display unit 1 to be 20. The display unit 1 can be positioned in the display interface shown in FIG. 4 according to the column 1 and the offset range which is greater than or equal to 0 and less than or equal to 20 of the content 1. The content 1 can be loaded in the display unit 1. For the content 2, according to the display unit type 1 of the content 2, one display unit whose type is the type 1, assuming that it is the display unit 2, can be obtained from the display unit recycle bin. The display unit 2 can be configured according to the height 15 of the content 2, i.e., configuring the height of the display unit 2 to be 15. The display unit 2 can be positioned in the display interface shown in FIG. 4 according to the column 1 and the offset range which is greater than 20 and less than or equal to 35 of the content 2. The content 2 can be loaded in the display unit 2. The contents 3, 4, 5, 6, 7, 8, 9, 10, 11, 12, 13, 14 and 15 can be loaded into the UI interface according to the above method, to obtain a display interface shown in FIG. 5.

Block 205: moving the display interface, and displaying contents in a first display range on the display screen of the terminal;

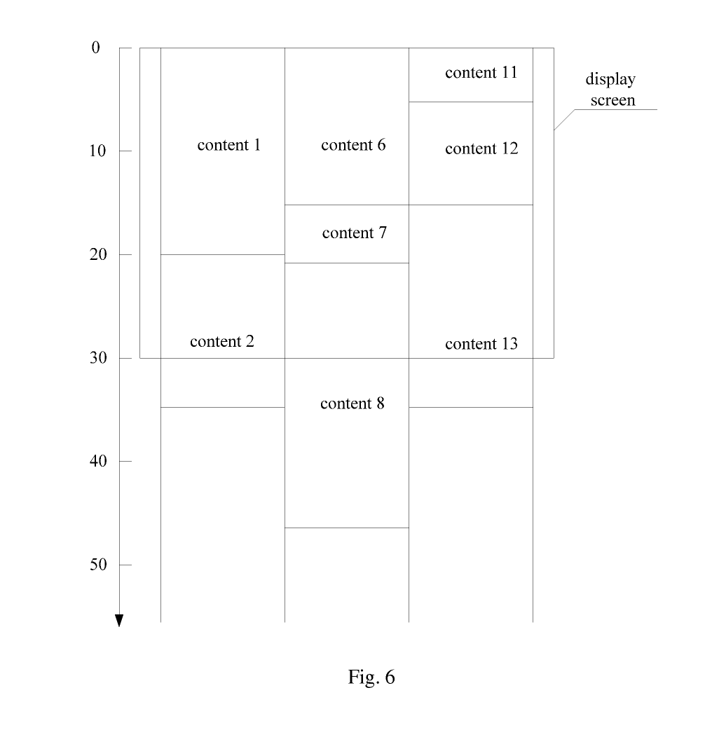

For example, referring to FIG. 6, for the first display range which is greater than or equal to 0 and less than or equal to 30, moving the display interface so that contents in the first display range which is greater than or equal to 0 and less than or equal to 30 can be moved to the display screen of the terminal and can be displayed on the display screen of the terminal.

When displaying contents on the display screen of the terminal, the user can move the contents upwardly or downwardly in the terminal. During the process that the user moves the contents, the terminal, the terminal periodically obtains displacement amount and movement direction of the contents moved by the user. The terminal loads the contents and displays the loaded contents for the user according to displacement amount and movement direction obtained in each period, which specifically includes following blocks 206-210.

Block 206: when the user moves displayed contents, periodically obtaining contents which move into the display screen of the terminal;

This block can specifically include following first and second steps, which can be:

The first step: obtaining displacement amount and movement direction of contents moved by the user in a current period, and obtaining a second display range according to the first display range, the displacement amount and the movement direction;

Specifically, when the user moves the displayed contents, obtaining displacement amount and movement direction of contents moved by the user in the current period; if the movement direction is downward, then performing a summing operation on the first display range and the displacement amount to obtain a second display range; if the movement direction is upward, then performing a difference operation on the first display range and the displacement amount to obtain a second display range.

For example, assuming: the terminal obtains that a movement direction of contents moved by the user in the current period is downward and a displacement amount of the moved contents is 15, the first display range is greater than or equal to 0 and less than or equal to 30; it can be calculated out that the second display range is greater than or equal to 15 and less than or equal to 45, according to the first display range which is greater than or equal to 0 and less than or equal to 30, the displacement amount of 30 and the movement direction which is downward.

Further, after obtaining the second display range, this block can also include:

obtaining contents which move out of the display screen of the terminal according to the second display range, and recycling display units corresponding to the contents which moves out of the display screen of the terminal.

Specifically, contents whose displacement amounts are not overlapped with the second display range can be obtained from contents currently included in the display interface. The obtained contents are contents which move out of the display screen of the terminal. The display units corresponding to the contents which move out of the display screen of the terminal can be cached into the recycle bin. Memory space occupied by the contents which move out of the display screen of the terminal can be released.

For example, the display interface currently includes the contents 1, 2, 6, 7, 8, 11, 12 and 13, the contents 6, 11 and 12 whose displacement amounts are not overlapped with the second display range which is greater than or equal to 15 and less than or equal to 45, the obtained contents 6, 11 and 12 are contents which move out of the display screen of the terminal. The display units respectively corresponding to the contents 6, 11 and 12 which move out of the display screen of the terminal can be cached into the recycle bin. Memory space respectively occupied by the contents 6, 11 and 12 which move out of the display screen of the terminal can be released.

The second step: obtaining contents moving into the display screen of the terminal according to the first display range and the second display range.

Specifically, contents whose displacement amounts are overlapped with the second display range but not overlapped with the first display range, can be obtained from contents needed to be displayed. The obtained contents whose displacement amounts are overlapped with the second display range but not overlapped with the first display range, are contents which move into the display screen of the terminal.

For example, the contents 3 and 14, whose displacement amounts are overlapped with the second display range which is greater than or equal to 15 and less than or equal to 45 but not overlapped with the first display range which is greater than or equal to 0 and less than or equal to 30 can be can be obtained from contents 1, 2, 3, 4, 5, 6, 7, 8, 9, 10, 11, 12, 13, 14 and 15 needed to be displayed. The obtained contents 3 and 14 whose displacement amounts are overlapped with the second display range which is greater than or equal to 15 and less than or equal to 45 but not overlapped with the first display range which is greater than or equal to 0 and less than or equal to 30, are contents on the display screen of the terminal.

Block 207: according to column numbers, types of display units and the displacement amounts of contents moving into the display screen of the terminal, loading in multiple columns contents which move into the display screen of the terminal into the display interface.

Specifically, for any one content moving into the display screen of the terminal, a corresponding display unit can be obtained according to the display unit type corresponding to this content. The display unit can be configured according to the height of the content. The display unit can be positioned in the display interface according to the column number and the offset range of the content. The content can be loaded in the display unit. Every other selected contents can be loaded into the display interface according to the above method.

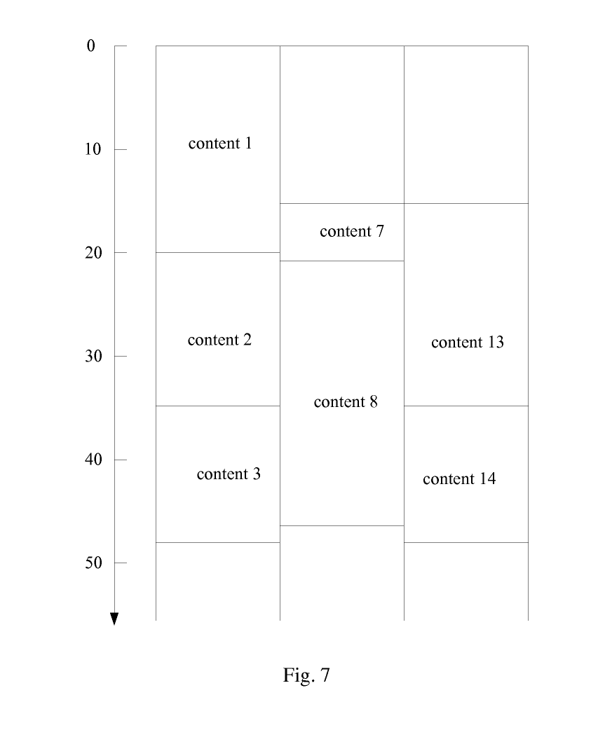

For example, as shown in FIG. 7, the display unit can be configured according to the height 13 of the content 3 which moves into the display screen of the terminal. The display unit can be positioned in the display interface according to the column 1 and the offset range which is greater than 35 and less than or equal to 48 of the content 3. The content 3 can be loaded in the display unit. For the content 14 which moves into the display screen of the terminal, according to the display unit type 3 of the content 14, one corresponding display unit can be obtained. The display unit can be configured according to the height 12 of the content 14. The display unit can be positioned in the display interface according to the column 3 and the offset range which is greater than 35 and less than or equal to 48 of the content 14. The content 14 can be loaded in the display unit.

Block 208: moving the display interface, and displaying contents in the second display range on the display screen of the terminal.

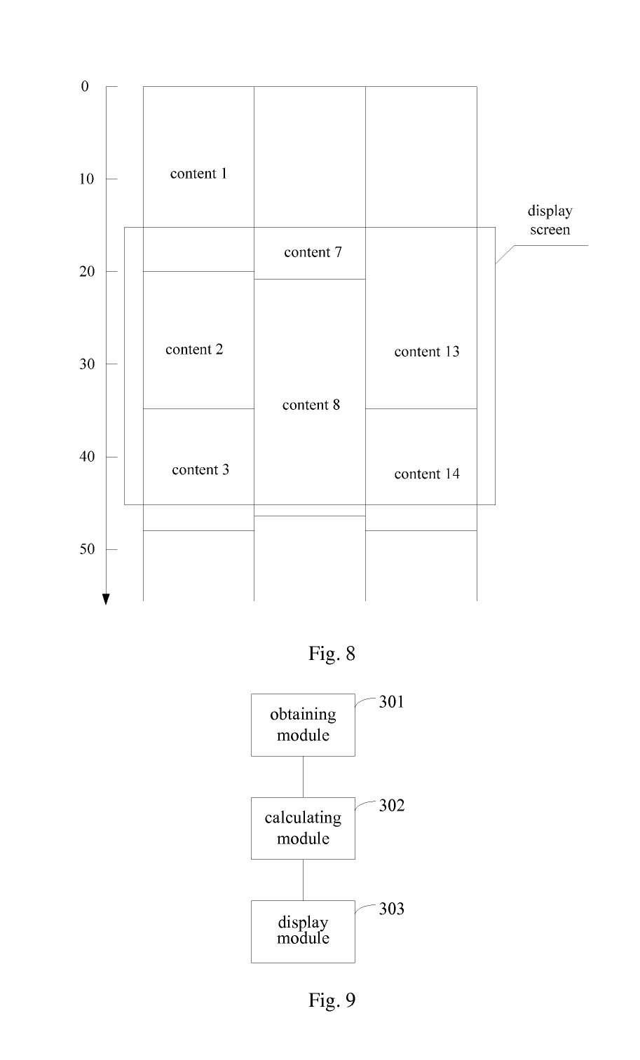

For example, referring to FIG. 8, for the second display range which is greater than or equal to 15 and less than or equal to 45, moving the display interface so that contents in the second display range which is greater than or equal to 15 and less than or equal to 45 can be moved to the display screen of the terminal and can be displayed on the display screen of the terminal.

Further, the first display range can be updated to be the second display range.

If the user continues to move displayed contents, when entering into the next period, the terminal obtains displacement amount and movement direction of contents moved by the user, and returns to performing the block 207.

In one embodiment of the present disclosure, obtaining configuration information of contents needed to be displayed, and the configuration information of the contents at least including column numbers, line numbers, heights and display unit types; calculating offset ranges of the contents according to the column numbers, line numbers and heights of the contents; displaying the contents respectively in multiple columns according to the column numbers, display unit types and the offset ranges of the contents, since the contents can be displayed in multiple columns on a display screen of a terminal, and thus the utilization of space resources of the display screen of the terminal can be improved.

### Embodiment 3

As shown in FIG. 9, this embodiment of the present disclosure provides an apparatus for displaying content, which includes:

an obtaining module 301 configured to obtain configuration information of contents needed to be displayed, and the configuration information of the contents at least including column numbers, line numbers, heights and display unit types;

a calculating module 302 configured to calculate offset ranges of the contents according to the column numbers, line numbers and heights of the contents;

a display module 303 configured to display the contents respectively in multiple columns according to the column numbers, display unit types and the offset ranges of the contents.

The display module 303 includes:

a first selecting unit configured to select contents whose offset ranges overlap with a first display range from the contents needed to be displayed; the first display range being greater than or equal to 0 and less than or equal to a height of the display screen of the terminal;

a first loading unit configured to load selected contents in multiple columns into a display interface, according to column numbers, display unit types and offset ranges of the selected contents;

a first display unit configured to move the display interface and display contents in a first display range on the display screen of the terminal.

The first loading unit includes:

a first obtaining sub-unit configured to obtain a corresponding display unit according to a display unit type corresponding to a selected content;

a positioning sub-unit configured to configure the display unit according to a height of the selected content and position the display unit in the display interface according to a column number and an offset range of the selected content;

a loading sub-unit configured to load the selected content into the display unit.

The first obtaining sub-unit is specifically configured to determine whether there is a corresponding displaying unit in a display unit recycle bin, according to the display unit type corresponding to the selected content; if there is a corresponding displaying unit in the display unit recycle bin, then obtain the corresponding display unit from the display unit recycle bin according to the display unit type corresponding to the selected content; if there is not a corresponding displaying unit in the display unit recycle bin, then create a corresponding displaying unit according to the display unit type corresponding to the selected content.

Further, the apparatus can also include:

an obtaining-displaying module configured to, when the user moves displayed contents, periodically obtain contents which move into the display screen of the terminal and display in multiple columns the contents which move into the display screen of the terminal.

The obtaining-displaying module includes:

a first obtaining unit configured to obtain a displacement amount and a movement direction of contents moved by the user in a current period, and obtain a second display range according to the first display range, the obtained displacement amount and the movement direction;

a second obtaining unit configured to obtain contents moving into the display screen of the terminal according to the first display range and the second display range;

a second loading unit configured to, according to column numbers, types of display units and the displacement amount of contents which move into the display screen of the terminal, load in multiple columns the contents which move into the display screen of the terminal into the display interface;

a second display unit configured to move the display interface and display contents in the second display range on the display screen of the terminal.

The first obtaining unit includes:

a second obtaining sub-unit configured to obtain displacement amount and movement direction of contents moved by the user in the current period;

a first computing unit configured to, if the obtained movement direction is downward, then perform a summing operation on the first display range and the obtained displacement amount to obtain a second display range;

a second computing unit configured to, if the obtained movement direction is upward, then perform a difference operation on the first display range and the obtained displacement amount to obtain a second display range.

The second obtaining unit is specifically configured to obtain contents whose displacement amounts are overlapped with the second display range but not overlapped with the first display range from contents needed to be displayed.

Further, the apparatus can also include:

an updating module configured to update the first display range to be the second display range.

Further, the apparatus can also include:

a recycling module configured to, obtain contents which move out of the display screen of the terminal according to the second display range, and recycle display units corresponding to the contents which moves out of the display screen of the terminal.

The recycling module includes:

a third obtaining unit configured to obtain contents whose displacement amounts are not overlapped with the second display range from contents currently included in the display interface; the contents whose displacement amounts are not overlapped with the second display range being contents which move out of the display screen of the terminal;

a cache unit configured to cache display units corresponding to the contents which move out of the display screen of the terminal into a display unit recycle bin;

a release unit configure to release memory space occupied by the contents which move out of the display screen of the terminal.

In one embodiment of the present disclosure, obtaining configuration information of contents needed to be displayed, and the configuration information of the contents at least including column numbers, line numbers, heights and display unit types; calculating offset ranges of the contents according to the column numbers, line numbers and heights of the contents; displaying the contents respectively in multiple columns according to the column numbers, display unit types and the offset ranges of the contents, since the contents can be displayed in multiple columns on a display screen of a terminal, and thus the utilization of space resources of the display screen of the terminal can be improved.

In the embodiments, as shown in FIGS. 5-8, on the display screen, the display units can be arranged in form of a grid which includes a plurality of grid members each corresponding to one of the display units. The grid members may have same sizes or different sizes (as shown in FIGS. 5-8). In other words, the contents displayed on the display screen can be arranged in form of a grid. Therefore, the utilization of space resources of the display screen of the terminal can be improved.

The methods, modules, units and terminals described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. In one example, there is provided a system or apparatus having a storage medium that stores machine-readable program codes for implementing functions of any of the above examples and that may cause the system or the apparatus (or CPU or MPU) to read and execute the program codes stored in the storage medium.

In this situation, the program codes read from the storage medium may implement any one of the above examples.

The storage medium for storing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What have been described and illustrated herein are examples along with some variations. The terms, descriptions and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

1. A method for displaying content comprising:
obtaining configuration information of contents needed to be displayed, wherein the configuration information of the contents at least includes column numbers, line numbers, heights and display unit types;
calculating offset ranges of the contents according to the column numbers, line numbers and heights of the contents; and
displaying the contents respectively in multiple columns according to the column numbers, display unit types and the offset ranges of the contents;
wherein the displaying the contents respectively in multiple columns according to the column numbers, display unit types and the offset range of the contents comprises:
selecting contents whose offset ranges overlap with a first display range from the contents needed to be displayed, wherein the first display range is greater than or equal to 0 and less than or equal to a height of a display screen of a terminal;
loading the selected contents in multiple columns into a display interface according to column numbers, display unit types and offset ranges of the selected contents; and
moving the display interface and displaying contents in the first display range on the display screen of the terminal.

2. (canceled)

3. The method of claim 1, wherein the loading the selected contents in multiple columns into a display interface according to column numbers, display unit types and offset ranges of the selected contents comprises:
obtaining corresponding display units according to the display unit types corresponding to the selected contents;
configuring the display units according to heights of the selected contents, and positioning the display units in the display interface according to the column numbers and the offset ranges of the selected contents; and
loading the selected contents into the display units.

4. The method of claim 3, wherein the obtaining corresponding display units according to the display unit types corresponding to the selected contents comprises:
determining whether there are corresponding displaying units in a display unit recycle bin, according to the display unit types corresponding to the selected contents;
if there are corresponding displaying units in the display unit recycle bin, then obtaining the corresponding display units from the display unit recycle bin according to the display unit types corresponding to the selected contents;
if there are not corresponding displaying units in the display unit recycle bin, then creating corresponding displaying units according to the display unit types corresponding to the selected contents.

5. The method of claim 1, wherein after the displaying the contents respectively in multiple columns according to the column numbers, display unit types and the offset ranges of the contents, the method further comprises:
when the user moves displayed contents, periodically obtaining contents which move into the display screen of the terminal and displaying the contents which move into the display screen of the terminal respectively in multiple columns.

6. The method of claim 5, wherein the periodically obtaining contents which move into the display screen of the terminal and displaying the contents which move into the display screen of the terminal respectively in multiple columns comprises:
obtaining a displacement amount and a movement direction of contents moved by a user in a current period, and obtain a second display range according to the first display range, the displacement amount and the movement direction;
obtaining the contents which move into the display screen of the terminal according to the first display range and the second display range;
according to column numbers, display unit types and the displacement amount of the contents which move into the display screen of the terminal, load in multiple columns the contents which move into the display screen of the terminal into the display interface;
moving the display interface and displaying contents in the second display range on the display screen of the terminal.

7. The method of claim 6, wherein the obtaining a second display range according to the first display range, the displacement amount and the movement direction comprises:
if the movement direction is downward, performing a summing operation on the first display range and the displacement amount to obtain a second display range;
if the movement direction is upward, performing a difference operation on the first display range and the displacement amount to obtain a second display range.

8. The method of claim 6, wherein the obtaining the contents which move into the display screen of the terminal according to the first display range and the second display range comprises:
obtaining contents whose displacement amounts are overlapped with the second display range but not overlapped with the first display range from the contents needed to be displayed; wherein the contents whose displacement amounts are overlapped with the second display range but not overlapped with the first display range are the contents which move into the display screen of the terminal.

9. The method of claim 6, wherein after the displaying contents in the second display range on the display screen of the terminal, the method further comprises:
updating the first display range to be the second display range.

10. The method of claim 6, wherein after the obtaining a second display range according to the first display range, the displacement amount and the movement direction, the method further comprises:
obtaining contents which move out of the display screen of the terminal according to the second display range and recycling display units corresponding to the contents which moves out of the display screen of the terminal.

11. The method of claim 10, wherein the obtaining contents which move out of the display screen of the terminal according to the second display range and recycling display units corresponding to the contents which moves out of the display screen of the terminal comprises:
obtaining contents whose displacement amounts are not overlapped with the second display range from contents currently included in the display interface; wherein the contents whose displacement amounts are not overlapped with the second display range are the contents which move out of the display screen of the terminal;
caching the display units corresponding to the contents which move out of the display screen of the terminal into a display unit recycle bin; and
releasing memory space occupied by the contents which move out of the display screen of the terminal.

12. An apparatus for displaying content comprising:
an obtaining module configured to obtain configuration information of contents needed to be displayed, wherein the configuration information of the contents at least includes column numbers, line numbers, heights and display unit types;
a calculating module configured to calculate offset ranges of the contents according to the column numbers, the line numbers and the heights of the contents;
a display module configured to display the contents respectively in multiple columns according to the column numbers, the display unit types and the offset ranges of the contents;
wherein the display module includes:
a first selecting unit configured to select contents whose offset ranges overlap with a first display range from the contents needed to be displayed; wherein the first display range is greater than or equal to 0 and less than or equal to a height of a display screen of a terminal;
a first loading unit configured to load the selected contents in multiple columns into a display interface, according to column numbers, display unit types and offset ranges of the selected contents; and
a first display unit configured to move the display interface and display contents in the first display range on the display screen of the terminal.

13. (canceled)

14. The apparatus of claim 12, wherein the first loading unit comprises:
a first obtaining sub-unit configured to obtain corresponding display units according to the display unit types corresponding to the selected contents;
a positioning sub-unit configured to configure the display units according to the heights of the selected contents and position the display units in the display interface according to the column numbers and the offset ranges of the selected content; and
a loading sub-unit configured to load the selected contents into the display units.

15. The apparatus of claim 14, wherein
the first obtaining sub-unit is configured to determine whether there are corresponding displaying units in a display unit recycle bin according to the display unit types corresponding to the selected contents; if there are corresponding displaying units in the display unit recycle bin, obtain the corresponding display units from the display unit recycle bin according to the display unit types corresponding to the selected contents; if there are not corresponding displaying units in the display unit recycle bin, create corresponding displaying units according to the display unit types corresponding to the selected contents.

16. The apparatus of claim 12, wherein the apparatus further comprises:
an obtaining-displaying module configured to, when a user moves displayed contents, periodically obtain contents which move into the display screen of the terminal and display in multiple columns the contents which move into the display screen of the terminal.

17. The apparatus of claim 16, wherein the obtaining-displaying module comprises:
a first obtaining unit configured to obtain a displacement amount and a movement direction of contents moved by the user in a current period, and obtain a second display range according to the first display range, the displacement amount and the movement direction;
a second obtaining unit configured to obtain contents which move into the display screen of the terminal according to the first display range and the second display range;
a second loading unit configured to, according to column numbers, display unit types and the displacement amount of the contents which move into the display screen of the terminal, load in multiple columns the contents which move into the display screen of the terminal into the display interface;
a second display unit configured to move the display interface and display contents in the second display range on the display screen of the terminal.

18. The apparatus of claim 17, wherein the first obtaining unit comprises:
a second obtaining sub-unit configured to obtain the displacement amount and the movement direction of the contents moved by the user in the current period;
a first computing unit configured to, if the movement direction is downward, perform a summing operation on the first display range and the displacement amount to obtain a second display range; and
a second computing unit configured to, if the movement direction is upward, perform a difference operation on the first display range and the displacement amount to obtain a second display range.

19. The apparatus of claim 17, wherein
the second obtaining unit is configured to obtain contents whose displacement amounts are overlapped with the second display range but not overlapped with the first display range from the contents needed to be displayed; wherein the contents whose displacement amounts are overlapped with the second display range but not overlapped with the first display range are the contents which move into the display screen of the terminal.

20. The apparatus of claim 17, wherein the apparatus further comprises:
an updating module configured to update the first display range to be the second display range.

21. The apparatus of claim 17, wherein the apparatus further comprises:
a recycling module configured to, obtain contents which move out of the display screen of the terminal according to the second display range and recycle display units corresponding to the contents which moves out of the display screen of the terminal.

22. The apparatus of claim 21, wherein the recycling module includes:
a third obtaining unit configured to obtain contents whose displacement amounts are not overlapped with the second display range from contents currently included in the display interface; wherein the contents whose displacement amounts are not overlapped with the second display range are the contents which move out of the display screen of the terminal;
a cache unit configured to cache display units corresponding to the contents which move out of the display screen of the terminal into a display unit recycle bin;
a release unit configure to release memory space occupied by the contents which move out of the display screen of the terminal.

23. (canceled)

24. (canceled)
